(19) United States
(12) Patent Application Publication
(10) Pub. No.: US 2019/0352956 A1
(43) Pub. Date: Nov. 21, 2019

(54) Flashing Retainer Assembly

(71) Applicant: Adam Ugliuzza, Lemoyne, PA (US)

(72) Inventor: Adam Ugliuzza, Lemoyne, PA (US)

(21) Appl. No.: 15/985,178

(22) Filed: May 21, 2018

(51) Int. Cl. E06B 1/62; E04B 1/41

(52) U.S. Cl. CPC E06B 1/62; E06B 2001/628; E04B 1/40

(57) ABSTRACT

The present invention provides an improved method for mounting and securing Flashing at exterior wall fenestration openings by using a three part system, Mounting Channel, Flashing, and Retaining Clip. The Mounting Channel is mounted at the opening or transition area when the framing is complete. The Flashing is inserted into the Mounting Channel. The Flashing is held in place with a Retaining Clip that uses tension to retain the Flashing in place. In this manner, the Flashing can be installed without the need for any mechanical fasteners and is designed to attach Flashing in a manner that allows fenestration to seal directly to the Air Barrier and reduce thermal bridging. Further, because the Flashing can be installed after all other exterior building components are installed, it is less likely that the Flashing will be damaged during the construction process.

### CROSS REFERENCE TO RELATED APPLICATIONS

The application is based upon and claims priority from a Provisional Patent Application filed as Jun. 5, 2017 Application No. 62/603,513 by Ugliuzza.

### STATEMENT REGARDING FEDERALLY SPONSORED RESEARCH OR DEVELOPMENT

This invention was not made with any government support.

### BACKGROUND OF THE INVENTION

Flashing is the method of transitioning or terminating of exterior building components. Metal flashing is typically used at exterior wall opening conditions that employ fenestration components, including but not limited to, windows, doors, storefront, window wall, curtain wall, louvers and building enclosure transitions and terminations of, including but not limited to, cladding, weather barrier membranes, waterproofing and roofing. Metal flashing's functional purpose is to provide environmental protection and to divert water away from the building at transitions or terminations of exterior building components. The flashing's aesthetic purpose is to provide an attractive transition or termination of exterior building components.

The current method for flashing involves the placing of flashing after the support framing is complete. The flashing is typically secured with mechanical fasteners such as nails or screws that penetrate the flashing. In many cases, the mechanical fasteners secure the flashing at a horizontal surface. The penetrations created by the attachment of the flashing and the attachment are typically sealed with an elastomeric mastic or sealant. Functionally, with the current method, the penetrations for the attachment allow for a point of entry for future water infiltration when the mastic or sealant fails, is not installed properly or is not installed at all.

Further, flashing is often required to be mounted prior to adjacent exterior building components in order to conceal the mechanical fasteners that are used to attach the metal flashing. This condition limits the ability to modify or replace the metal flashing later without removal of the concealing exterior building component. This installation method also limits construction sequencing and can create conditions where the metal flashing is exposed and more prone to damage before the remaining exterior building components can be installed.

### BRIEF SUMMARY OF THE INVENTION

The present invention provides an improved method by using a three part system, Mounting Channel, Flashing, and Retaining Clip. The Mounting Channel is mounted at the opening or transition area when the framing is complete. Once installation of the adjacent exterior building component is complete, the Flashing can then be installed into the Mounting Channel. This Flashing is a traditional style flashing typically made out of aluminum or other materials with similar characteristics. The Flashing is inserted into the Mounting Channel. The Flashing is held in place with a Retaining Clip that uses tension to retain the Flashing in place. In this manner, the Flashing can be installed without the need for any mechanical fasteners, which create a point of penetration. Further, because the Flashing can be installed after all other exterior building components are installed it is less likely that the Flashing will be damaged during the construction process.

### BRIEF DESCRIPTION OF DRAWINGS

FIG. 1: Cross-section of Assembled Apparatus

FIG. 2: Cross-section of Mounting Channel with Exterior Building Components

FIG. 3: Cross-Section of Mounting Channel

FIG. 4: Cross-section of Alternate Embodiments of Mounting Channel

FIG. 4A: Alternate Embodiment with Primary Member removed for mounting on one plane where the flashing is perpendicular to the attachment plane.

FIG. 4B: Alternate Embodiment with Second Member removed for mounting at opening of existing wall.

FIG. 4C Alternate Embodiment with Primary Member and Second Member removed for mounting flashing to one plane where the flashing is parallel to the attachment plane.

FIG. 5: Cross Section of Retaining Clip

FIG. 6: Cross Section of Flashing

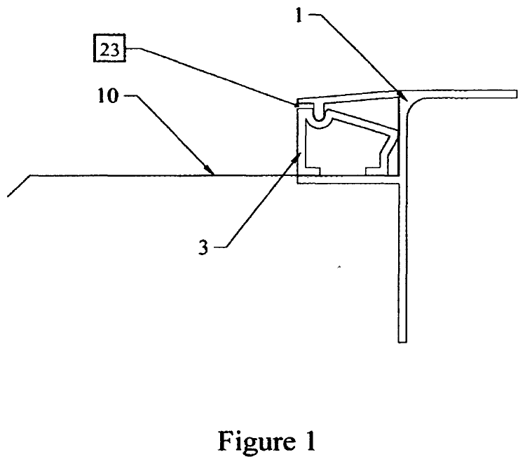

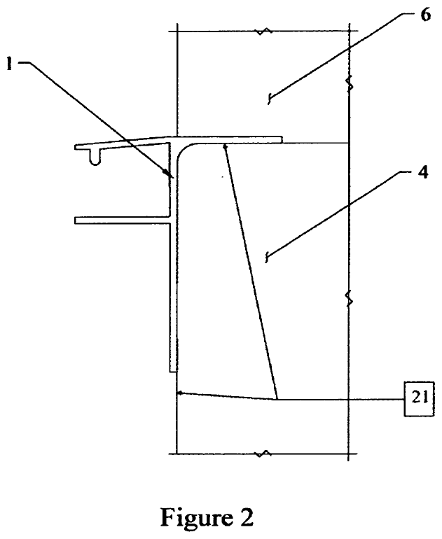

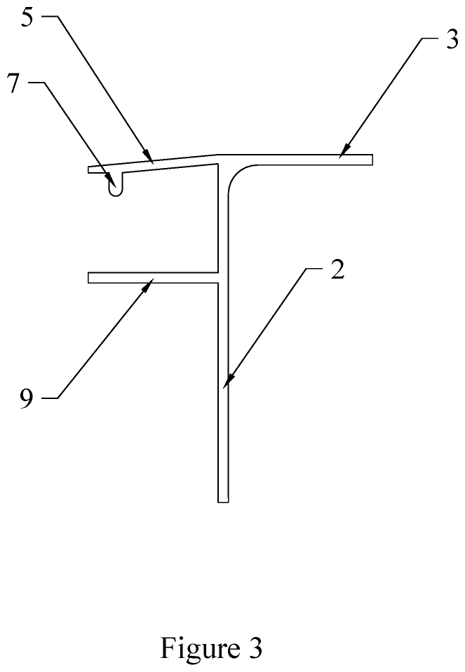

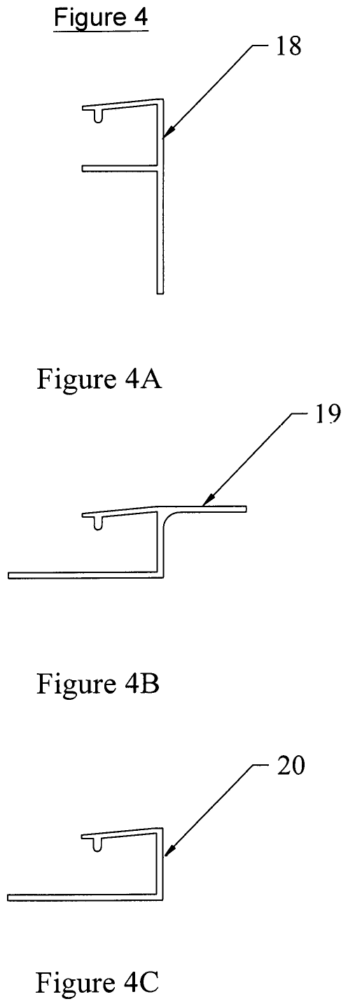

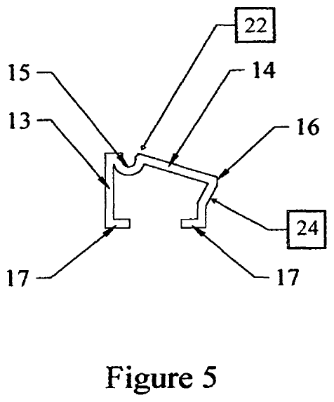

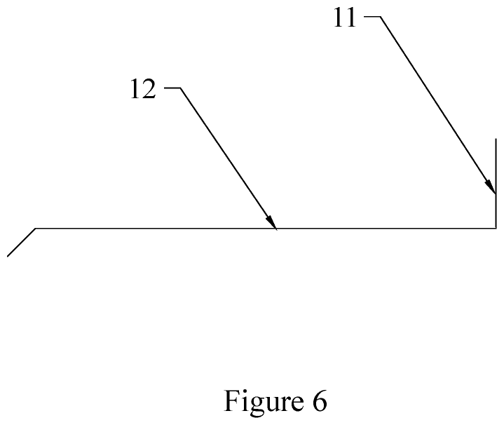

### LABEL LIST

1. Mounting Channel

2. Primary Member

3. Second Member

4. Building Structure

5. Retaining Arm Component

6. Window or other Building Material

7. Key

8. Retaining Clip

9. Flashing Mounting Component

10. Flashing

11. Short Bent Leg

12. Projected Leg

13. First Element

14. Upper Surface

15. Key Way

16. Rear Element

17. Foot Elements

18. Mounting Channel, Alternate Embodiment 1

19. Mounting Channel, Alternate Embodiment 2

20. Mounting Channel, Alternate Embodiment 3

### DETAILED DESCRIPTION OF PREFERRED EMBODIMENT

The invention is a Flashing Retainer Assembly.

A three part apparatus for Flashing at transitions and terminations of exterior building components. The first part being the “Mounting Channel” (1), is made of a rigid elastic material, which in the preferred embodiment is stainless steel, aluminum, or plastic. The “Mounting Channel” consists of the Primary Member (2) that is connected to the Second Member (3) that lies at a right angle to the Primary Member (2) and projects towards the interior of the structure. The Second Member (3) and the Primary Member (2) are affixed to the Building Structure (4) with either mechanical fasteners or adhesive.

The “Retaining Arm Component” (5) is oriented at acute angle to the Primary Member (2). The Retaining Arm Component (5) is oriented at an acute angle to prevent the accumulation of water on a horizontal surface at the exterior side of the Window or other Building Material (6). Any water that falls on the Retaining Arm Component (5) will drain outward toward the exterior of the building along the Retaining Arm Component (5). Additionally the acute angle helps retain and lock the Retaining Clip (8). Located near the outermost portion of the Retaining Arm Component (5) is a vertical protrusion (the “Key”) (7) that projects from the Retaining Clip (8) side of the Retaining Arm Component (5). The Key provides a mechanical means to secure the Retaining Clip (8). In alternate embodiments the Key (7) is rectangular or round in shape.

Further, projecting from the Primary Member (2) on the same side as the Retaining Arm Component (5) is the “Flashing Mounting Component” (5). The Flashing Mounting Component (5) is the base upon which the “Retaining Clip” (8) rests. In the preferred embodiment the Flashing Mounting Component (9) is perpendicular to the Primary Member (2). The Primary Member (2) acts as stop, limiting the insertion depth of the Retaining Clip (8) and the Flashing. The Flashing Mounting Component also helps to support the Flashing (10). The Flashing Mounting Component (9) receives the Flashing (10) and serves as a base for the insertion of the Retaining Clip (8).

There are three alternate embodiments of the Mounting Channel. The First Alternate Embodiment (18) has a portion of the Primary Member removed for mounting on one plane where the flashing is perpendicular to the attachment plane. The Second Alternate Embodiments (19) has a portion of the Second Member removed for mounting at the opening of an existing wall. The Third Alternate Embodiment (20) has a portion of the Primary Member and Second Member removed for mounting flashing to one plane where the flashing is parallel to the attachment plane. Flashing (10) is the second part of the apparatus. In the preferred embodiment the Flashing (10) is any type of commercially available Flashing (typically being aluminum or stainless steel) that is bent at approximately a right angle so that there is a Short Bent Leg (11) and Projected Leg (12). The short bent leg (11) interfaces with the primary member (2) and the portion of the projected leg beyond the Flashing Mounting Component (9) may be bent or shaped to conform to the adjoining exterior building component. In the alternate embodiment the Short Bent leg of the Flashing terminates with a hemmed edge.

The “Retaining Clip” (8) is the third part of the apparatus. The Retaining Clip (8) serves the function of mechanically securing the Flashing (10) to the Mounting Channel (1). The Retaining Clip (8) in the preferred embodiment is made of the same material as the Mounting Channel (1). The Retaining Clip (8) consists of four distinct elements.

The First Element (13) is the outer edge of the Retaining Clip (8). This first element is generally oriented at a right angle to the Flashing Mounting Component (9) to allow for the drainage of water to the projected leg of the Flashing (10). Further, the First Element (13) is oriented in such a manner to allow and install to press the Retaining Clip (8) into place using their thumbs.

The second element of the Retaining Clip is the Upper Surface (14). The Upper Surface (14) of the Retaining Clip (8) contains a Key Way (15) to accept the Key (7). The Key (7) and the Key Way (15) interlock in a manner to securely hold the Retaining Clip (8) in place. Further, the Upper Surface (14) of the Retaining Clip (8) is oriented at an angle to allow for it to wedge open the Flashing Mounting Component (9) and the Retaining Arm Component (5) as the Retaining Clip (8) is inserted. The Key (7) and the Key Way (15) can be released by applying upward pressure to the lower surface of the Retaining Arm Component (5).

The third and fourth elements of the Retaining Clip (8) are designed to secure the Flashing in the Mounting Channel. The third element of the Retaining Clip is the Rear Element (16) of the Retaining Clip (8). The third element of the Retaining Clip (8) will contact the Bent Leg (11) of the Flashing (10) securing it against the Primary Member (2). When the Retaining Clip (8) is engaged the Rear Element (16) contacts the Primary Member (2) which prevents the Retaining Clip (8) to resist rotational movement of the Retaining Clip (8). The fourth element of the Retaining Clip are the Foot Elements (17). The Foot Elements (17) of the Retaining Clip contact the projected leg of the Flashing (12) using compressive force to secure it against the Flashing Mounting Component (9) eliminating the need for mechanical fasteners.

Together the three components, the Mounting Channel (1), Flashing (10) and Retaining Clip (8) create an improved apparatus for mounting flashing at exterior wall opening conditions that employ fenestration components, including but not limited to, windows, doors, storefront, window wall, curtain wall, louvers and building enclosure transitions and terminations of, including but not limited to, cladding, weather barrier membranes, waterproofing and roofing.

1. An exterior wall Flashing System for flashing the junction of an exterior wall and fenestration, comprised of a combination of: (a) A Mounting Channel and (b) Retaining Clip, that provides a rectilinear, uniform profile that can be used at opening sill, jamb or head conditions or when used to transition corners for opening perimeter flashing applications, thereby eliminating the gap caused by non-rectilinear profiles; the exterior wall Flashing System, comprised of the Mounting Channel, Retaining Clip and flashing may be installed before or after the cladding and fenestration.

2. The Flashing Channel of claim 1, wherein the Mounting Channel is oriented to drain water away from the building components.

3. The Flashing System of claim 1, wherein no penetrating fasteners are required to secure the flashing whereby the Mounting Channel applies a compressive force on the Retaining Clip (Original) claim 4 and the Retaining Clip and Mounting Channel secure the Flashing with a compressive force along the horizontal and vertical members of the Mounting Channel (Original) claim 5 by employing four (4) points of contact (i) the Key/Key Way; (ii) Inner Foot Element; (iii) Outer Foot Element; and (iv) Rear Element that maintain consistent pressure and do not allow rotation of the Flashing or the Retaining Clip; the Rear Element and the rear Foot Element of the Retaining Clip are connected by an Angled Leg (New) Specification, (22) and the angle of the Leg is designed to accommodate varying thicknesses of Flashing and Flashing Splice Joints while the four (4) points of contact occur within the Mounting Channel, allowing the rectilinear profile to be maintained.

4. (canceled)

5. (canceled)

6. The exterior wall Flashing System of claim 3, wherein the flashing is terminated with a short leg to lock the flashing to the Retaining Clip.

7. The exterior wall Flashing System of claim 3, wherein the flashing is secured using a key in the Mounting Channel and a key way in the Retaining Clip; the keyway and matching key are semi-circular in shape (Original) claim 9 and wherein the semi-circular shape reduces friction when wedging mounting channel open.

8. (canceled)

9. (canceled)

10. (canceled)
a. Attaches a Mounting Channel to the structural framing,
b. Inserts the flashing into the Mounting Channel,
c. Secures the flashing with a Retaining Clip.

11. (canceled)

12. (canceled)

13. The method of installing flashing described in claims 1 and 3, wherein the installer inserts the Retaining Clip with his hands without the need for any tools and can remove the Retaining Clip by wedging open the Flashing Mounting Component and the Mounting Arm Component and disengaging the key from the keyway (Original) claim 15.

14. (canceled)

15. (canceled)

16. The Flashing System of (Amended) claim 1 is implemented to be integral to the primary air and water control layer(s) at the interface of the exterior wall and fenestration.

17. The Flashing System of (Amended) claim 1 wherein the exterior wall Flashing System is implemented to be an isolated component that does not interrupt the continuity of the primary air and water control layer(s) at the interface of exterior wall and fenestration, as continuity of the primary air and water control layer(s) is achieved behind the exterior wall Flashing System.

18. The exterior wall Flashing System of claim 7 wherein Upper Surface of the Retaining Clip is oriented at an angle to wedge open the Flashing Mounting Component and the Retaining Arm Component as the Retaining Clip is inserted.

19. The exterior wall Flashing System of claim 7 wherein the leading edge of the Upper Surface is chamfered to allow the semi-circular key to slide into the keyway.

20. An exterior wall Flashing System that provides a method of installing flashing that prevents air leakage and water penetration into a fenestration opening through the area behind the cladding, comprising of an exterior wall Flashing System that extends from the cladding to fenestration.

21. An exterior wall Flashing System that provides a method of installing flashing that accommodates continuous tie-in and sealing of the air and water control layer(s) to the primary seal of fenestration, which is located at the plane of air and water tightness of the fenestration, such that the interface of fenestration and exterior wall provides continuous air and water control and can be tested as such prior to the installation of the cladding.

22. The exterior wall Flashing System of (New) claim 21 that provides a method of installing flashing such that fenestration can be installed before or after the cladding.

23. An exterior wall Flashing System that provides the method of installing flashing around the perimeter of a fenestration opening with non-spliced metal or membrane corners.

24. An exterior wall Flashing System where the secondary member of the Mounting Channel returns to conceal the air and water barrier, or in an alternate embodiment for sill conditions, protects a drainage material to weep opening.

25. The exterior wall Flashing System of (Amended) claim 1 that provides a thermally improved attachment that reduces the transfer of heat between the exterior and interior components of the building.
